(19) United States
(12) Patent Application Publication
(10) Pub. No.: US 2012/0168310 A1
(43) Pub. Date: Jul. 5, 2012

(54) Process for separating and recovering C4 dicarboxylic acids

(75) Inventors: Joseph Jump, Raleigh, NC (US); Stephen Brown, Davis, CA (US)

(73) Assignees: NOVOZYMES, INC., Davis, CA (US); NOVOZYMES NORTH AMERICA, INC., Franklinton, NC (US)

(21) Appl. No.: 13/379,585

(22) PCT Filed: Jun. 30, 2010
(86) PCT No.: PCT/US10/40616

§ 371 Date: Mar. 13, 2012

Related U.S. Application Data
(60) Provisional application No. 61/222,317, filed on Jul. 1, 2009.

(51) Int. Cl. B01D 61/44

(52) U.S. Cl. 204/537

(57) ABSTRACT

The present invention relates to processes for separating and recovering the C4 dicarboxylic acid, comprising: (a) subjecting an aqueous solution comprising a salt of the C4 dicarboxylic acid to concentrating electrodialysis to concentrate the salt of the C4 dicarboxylic acid in the aqueous solution; and (b) subjecting the resulting concentrate to bipolar membrane electrodialysis to convert the salt of the C4 dicarboxylic acid into the free acid of the C4 dicarboxylic acid.

### BACKGROUND OF THE INVENTION

1. Field of the Invention

The present invention relates to processes for separating and recovering a C4 dicarboxylic acid in an aqueous solution comprising a salt of the C4 dicarboxylic acid.

2. Description of the Related Art

Organic acids have a long history of commercial use in a variety of industries. For example, organic acids are used in the food and feed industries (citric acid, ascorbic acid, lactic acid, acetic acid, and gluconic acid), as monomers for the production of various polymers (adipic acid, lactic acid, acrylic acid, and itaconic acid), as metal chelators (gluconic acid), and as “green” solvents (acetic acid) (Sauer et al., 2008, Trends in Biotechnology 26: 100-108). Organic acids may themselves be commercial products or they may be chemical building blocks used in the manufacture of other chemicals. In addition to specialty applications, it has long been recognized that the C4 dicarboxylic acids can also serve as building block compounds for the production of large volume industrial chemicals, such as 1,4-butanediol, tetrahydrofuran, and gamma-butyrolactone. The cost of producing these large volume industrial chemicals by traditional petrochemical routes has increased significantly due to the high cost of petroleum derived building blocks.

Organic acids are produced commercially either by chemical synthesis from petroleum derived feedstocks (e.g., fumaric acid, malic acid, acrylic acid, and adipic acid) or by microbial fermentation (e.g., citric acid, lactic acid, gluconic acid, and itaconic acid). Some organic acids such as fumaric acid and malic acid can also be produced by microbial fermentation, but are currently produced commercially by chemical synthesis from petrochemical feedstocks due to lower production costs. However, the rising cost of petroleum derived building block chemicals, the geopolitical instability affecting crude oil prices, and the desire to implement manufacturing processes that utilize feedstocks derived from renewable resources have stimulated a renewed interest in producing organic acids and other chemicals by microbial fermentation.

Microbial production of C4 dicarboxylic acids (e.g., succinic acid, malic acid and fumaric acid) by fermentation has been studied extensively. Several bacteria have been developed for production of succinic acid by fermentation (Song and Lee, 2006, Enzyme and Microbial Technology 39: 352-361). Fumaric acid can be produced using the filamentous fungus Rhizopus oryzae (Engel et al., 2008, Appl. Microbiol. Biotechnol. 78:379-389). Malic acid has been produced at high levels in genetically engineered yeast (Saccharomyces cerevisiae) (Zelle et al., 2008, Appl. Environ. Microbiol. 74: 2766-2777) and naturally occurring filamentous fungi such as Aspergillus spp. (Magnason and Lasure, 2004, In: Advances in Fungal Biotechnology for Industry, Agriculture, and Medicine; Abe et al., 1962, U.S. Pat. No. 3,063,910; Bercovitz et al., 1990, Appl. Environ. Microbiol. 56: 1594-1597). Abe et al. (U.S. Pat. No. 3,063,910) and Bercovitz et al. (1990, Appl. Environ. Microbiol. 56: 1594-1597) reported high levels of malic acid production in several species of Aspergillus, and Battat et al. (1991, Biotechnol. Bioengineering, 37: 1108-1116) reported malic acid production as high as 113 g/L by Aspergillus flavus in a stirred fermentor under optimized conditions.

Improvement of C4 dicarboxylic acid production in microorganisms by genetic engineering will enable low cost production of the acids by fermentation. However, there remains a need in the art for improved methods for separating and recovering a C4 dicarboxylic acid from an aqueous solution, e.g., fermentation broth.

The present invention provides processes for separating and recovering the free acid of a C4 dicarboxylic acid in an aqueous solution comprising a salt of the C4 dicarboxylic acid.

### SUMMARY OF THE INVENTION

The present invention relates to processes for separating and recovering a C4 dicarboxylic acid, comprising:
(a) subjecting an aqueous solution comprising a salt of the C4 dicarboxylic acid to concentrating electrodialysis to concentrate the salt of the C4 dicarboxylic acid in the aqueous solution; and
(b) subjecting the resulting concentrate to bipolar membrane electrodialysis to convert the salt of the C4 dicarboxylic acid into the free acid of the C4 dicarboxylic acid.

The present invention also relates to processes for separating and recovering a salt of a C4 dicarboxylic acid, comprising: subjecting an aqueous solution comprising a salt of the C4 dicarboxylic acid to concentrating electrodialysis to concentrate the salt of the C4 dicarboxylic acid in the aqueous solution.

The present invention also relates to processes for separating and recovering a C4 dicarboxylic acid, comprising: subjecting an aqueous solution comprising a salt of the C4 dicarboxylic acid to bipolar membrane electrodialysis to convert the salt of the C4 dicarboxylic acid into the free acid of the C4 dicarboxylic acid.

### BRIEF DESCRIPTION OF THE FIGURES

FIG. 1 shows the conductivity within the diluate tank during concentrating electrodialysis.

FIG. 2 shows the conductivity within the brine tank during concentrating electrodialysis.

FIG. 3 shows the pH of the acid tank versus time.

FIG. 4 shows the drop in conductivity within the acid tank.

### DETAILED DESCRIPTION OF THE INVENTION

The present invention relates to processes for separating and recovering a C4 dicarboxylic acid (e.g., malic acid), comprising: (a) subjecting an aqueous solution comprising a salt of the C4 dicarboxylic acid to concentrating electrodialysis to concentrate the salt of the C4 dicarboxylic acid in the aqueous solution; and (b) subjecting the resulting concentrate to bipolar membrane electrodialysis to convert the salt of the C4 dicarboxylic acid into the free acid of the C4 dicarboxylic acid.

A process of the present invention is high yielding, allows for separation of neutral components (e.g., glucose) from the salt of the C4 dicarboxylic acid, has no waste effluent, and allows for the sodium hydroxide produced in the process to be recycled back to a fermentation for pH control. A process of the present invention can remove substantial amounts of color that sometimes occurs during fermentation, making the process a convenient method for simultaneous decolorizing treatment.

The present invention also relates to processes for separating and recovering a salt of a C4 dicarboxylic acid, comprising: subjecting an aqueous solution comprising a salt of the C4 dicarboxylic acid to concentrating electrodialysis to concentrate the salt of the C4 dicarboxylic acid in the aqueous solution.

The present invention also relates to processes for separating and recovering a C4 dicarboxylic acid, comprising: subjecting an aqueous solution comprising a salt of the C4 dicarboxylic acid to bipolar membrane electrodialysis to convert the salt of the C4 dicarboxylic acid into the free acid of the C4 dicarboxylic acid. Reference to “about” a value or parameter herein includes aspects that are directed to that value or parameter per se. For example, description referring to “about X” includes the aspect “X”.

As used herein and in the appended claims, the singular forms “a,” “or,” and “the” include plural referents unless the context clearly dictates otherwise. It is understood that the aspects of the invention described herein include “consisting” and/or “consisting essentially of” aspects.

Unless defined otherwise or clearly indicated by context, all technical and scientific terms used herein have the same meaning as commonly understood by one of ordinary skill in the art to which this invention belongs.

### C4 Dicarboxylic Acids and Salts Thereof

In the processes of the present invention, the C4 dicarboxylic acid can be any C4 dicarboxylic acid. In one aspect, the C4 dicarboxylic acid is malic acid. In another aspect, the C4 dicarboxylic acid is succinic acid. In another aspect, the C4 dicarboxylic acid is fumaric acid. In another aspect, the C4 dicarboxylic acid is part of an aqueous composition comprising a mixture of two or more C4 dicarboxylic acids (e.g., malic acid and succinic acid; malic acid and fumaric acid; succinic acid and fumaric acid; or malic acid, succinic acid and fumaric acid).

The salt of the C4 dicarboxylic acid can be any salt suitable for the processes of the present invention. The salt of the C4 dicarboxylic acid consists of the conjugate base of the C4 dicarboxylic acid and a cation. The cation can be any monovalent or divalent cation that can be used as the counter ion to the C4 dicarboxylic acid during electrodialysis. A monovalent cation is preferred because it possesses better ion mobility across an ion exchange membrane during electrodialysis. A divalent cation can be used but may be more prone to membrane fouling. In one aspect, the cation of the C4 dicarboxylic acid salt is an alkali metal (e.g., lithium, sodium, potassium). In one aspect, the cation of the C4 dicarboxylic acid salt is sodium. In another aspect, the cation of the C4 dicarboxylic acid salt is potassium. In another aspect, the cation of the C4 dicarboxylic acid salt is lithium. In another aspect, the cation of the C4 dicarboxylic acid salt is an alkali earth metal (e.g., magnesium, calcium). In one aspect, the cation of the C4 dicarboxylic acid salt is magnesium. In another aspect, the cation of the C4 dicarboxylic acid salt is calcium. In another aspect, the cation of the C4 dicarboxylic acid salt is an organic cation. In another aspect, the cation of the C4 dicarboxylic acid salt is polyatomic (e.g., ammonium). In one aspect, the C4 dicarboxylic acid salt is part of an aqueous composition comprising any two or more C4 dicarboxylic acid salts (e.g., any two or more C4 dicarboxylic acid salts mentioned herein, such as sodium and potassium). In another aspect, the pH of a fermentation is controlled with one base yielding only one salt of the C4 dicarboxylic acid. The base can be, for example, sodium hydroxide, potassium hydroxide, or ammonium hydroxide.

The aqueous solution comprising the salt of the C4 dicarboxylic acid can be any aqueous solution. In one aspect, the aqueous solution is a whole fermentation broth. In another aspect, the aqueous solution is a cell-free fermentation broth. The cell-free fermentation broth is a filtered solution with the majority of cellular debris and particulate matter removed (e.g., greater than 50%, greater than 75%, greater than 85%, greater than 90%, greater than 95%, or greater than 98% of the cellular debris and particulate matter removed).

Various fermentation methods known in the art can be used to produce the C4 dicarboxylic acid employing a microorganism (See, for example, Song and Lee, 2006, Enzyme and Microbial Technology 39: 352-361; Engel et al., 2008, Appl. Microbiol. Biotechnol. 78:379-389; Zelle et al., 2008, Appl. Environ. Microbiol. 74: 2766-2777; Magnason and Lasure, 2004, In: Advances in Fungal Biotechnology for Industry, Agriculture, and Medicine; Abe et al., 1962, U.S. Pat. No. 3,063,910; Bercovitz et al., 1990, Appl. Environ. Microbiol. 56: 1594-1597). The microorganism may be any microorganism, e.g., a prokaryote or a eukaryote, and/or any cell (e.g., any filamentous fungal cell, such as Aspergillus oryzae) capable of the recombinant production of a C4 dicarboxylic acid as described below.

The microorganism may be any gram-positive or gram-negative bacterium. Gram-positive bacteria include, but not limited to, Bacillus, Clostridium, Enterococcus, Geobacillus, Lactobacillus, Lactococcus, Oceanobacillus, Staphylococcus, Streptococcus, and Streptomyces. Gram-negative bacteria include, but not limited to, Campylobacter, E. coli, Flavobacterium, Fusobacterium, Helicobacter, Ilyobacter, Neisseria, Pseudomonas, Salmonella, and Ureaplasma.

The microorganism may be any Bacillus cell including, but not limited to, Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, and Bacillus thuringiensis cells. The bacterial microorganism may also be any Streptococcus cell including, but not limited to, Streptococcus equisimilis, Streptococcus pyogenes, Streptococcus uberis, and Streptococcus equi subsp. Zooepidemicus cells. The bacterial microorganism may also be any Streptomyces cell including, but not limited to, Streptomyces achromogenes, Streptomyces avermitilis, Streptomyces coelicolor, Streptomyces griseus, and Streptomyces lividans cells.

The microorganism may also be a eukaryote, such as a mammalian, insect, plant, or fungal cell.

In one aspect, the microorganism is a fungal cell. “Fungi” as used herein includes the phyla Ascomycota, Basidiomycota, Chytridiomycota, and Zygomycota (as defined by Hawksworth et al., In, Ainsworth and Bisby's Dictionary of The Fungi, 8th edition, 1995, CAB International, University Press, Cambridge, UK) as well as the Oomycota (as cited in Hawksworth et al., 1995, supra, page 171) and all mitosporic fungi (Hawksworth et al., 1995, supra).

In one aspect, the microorganism is a yeast cell. “Yeast” as used herein includes ascosporogenous yeast (Endomycetales), basidiosporogenous yeast, and yeast belonging to the Fungi Imperfecti (Blastomycetes). Since the classification of yeast may change in the future, for the purposes of this invention, yeast shall be defined as described in Biology and Activities of Yeast (Skinner, F. A., Passmore, S. M., and Davenport, R. R., eds, Soc. App. Bacteriol. Symposium Series No. 9, 1980).

The microorganism may be a Candida, Hansenula, Kluyveromyces, Pichia, Saccharomyces, Schizosaccharomyces, or Yarrowia cell such as a Kluyveromyces lactis,

Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis, or Yarrowia lipolytica cell.

The microorganism may be a filamentous fungal cell. “Filamentous fungi” include all filamentous forms of the subdivision Eumycota and Oomycota (as defined by Hawksworth et al., 1995, supra). The filamentous fungi are generally characterized by a mycelial wall composed of chitin, cellulose, glucan, chitosan, mannan, and other complex polysaccharides. Vegetative growth is by hyphal elongation and carbon catabolism is obligately aerobic. In contrast, vegetative growth by yeasts such as Saccharomyces cerevisiae is by budding of a unicellular thallus and carbon catabolism may be fermentative.

The filamentous fungi may be an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell. For example, the filamentous fungi may be an Aspergillus aculeatus, Aspergillus awamori, Aspergillus foetidus, Aspergillus fumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phlebia radiata, Pleurotus eryngii, Thielavia terrestris, Trametes villosa, Trametes versicolor, Trichoderma harzianum, Trichoderma koningii, Trichoderma longibrachiatum, Trichoderma reesei, or Trichoderma viride cell. In one aspect, the microorganism is Aspergillus oryzae.

In one aspect, the microorganism is a filamentous fungal strain that produces a C4 dicarboxylic acid. In another aspect, the microorganism is an Aspergillus strain that produces the C4 dicarboxylic acid. In a preferred aspect, the microorganism is a metabolically engineered microorganism. In the most preferred aspect, the microorganism is a metabolically engineered Aspergillus oryzae, Aspergillus sojae or Aspergillus flavus strain. Typically, the C4 dicarboxylic acid is produced by culturing the microorganism in a culture medium such that the C4 dicarboxylic acid is produced. In general, the culture media and/or culture conditions can be such that the microorganism grows to an adequate density and produces the C4 dicarboxylic acid efficiently.

For large-scale production processes, any method can be used such as those described elsewhere (Manual of Industrial Microbiology and Biotechnology, 2^{nd} Edition, Editors: A. L. Demain and J. E. Davies, ASM Press; and Principles of Fermentation Technology, P. F. Stanbury and A. Whitaker, Pergamon). Briefly, a large tank (e.g., a 400 liters, 800 liters, 2000 liters, or more fermentation tank) containing appropriate culture medium with, for example, glucose as a carbon source is inoculated with a particular microorganism. After inoculation, the microorganism is incubated to allow biomass to be produced. Once a desired biomass is reached, the broth containing the microorganism can be transferred to a second tank. This second tank can be any size. For example, the second tank can be larger, smaller, or the same size as the first tank. Typically, the second tank is larger than the first such that additional culture medium can be added to the broth from the first tank. In addition, the culture medium within this second tank can be the same as, or different from, that used in the first tank. For example, the first tank can contain medium with xylose, while the second tank contains medium with glucose.

Production of the C4 dicarboxylic acid can be performed by batch fermentation, fed-batch fermentation, or continuous fermentation. In certain aspects, it is desirable to perform the fermentation under reduced oxygen or anaerobic conditions for certain microorganisms. In other aspects, C4 dicarboxylic acid production can be performed with oxygen; and, optionally with the use of an air-lift or equivalent fermentor.

Fermentation parameters are dependent on the microorganism used for production of the C4 dicarboxylic acid. Cultivation of the microorganism is preferably performed under aerobic or anaerobic conditions for about 0.5 to about 240 hours. During cultivation, temperature is preferably controlled at about 25° C. to about 45° C., and pH is preferably controlled at about 5 to about 8. The pH can be adjusted using common acids or bases such as acetic acid or sodium hydroxide. In a preferred aspect, the pH of the fermentation is adjusted using one base so that the C4 dicarboxylic acid is in the form of only one salt of the C4 dicarboxylic acid. The pH of the fermentation should be sufficiently high enough to allow growth of the microorganism and C4 dicarboxylic acid production by the microorganism.

In the production methods of the present invention, the cells are cultivated in a nutrient medium suitable for production of the C4 dicarboxylic acid using methods well known in the art. For example, the cell may be cultivated by shake flask cultivation, and small-scale or large-scale fermentation (including continuous, batch, fed-batch, or solid state fermentations) in laboratory or industrial fermentors performed in a suitable medium and under conditions allowing the C4 dicarboxylic acid to be expressed and/or isolated. The cultivation takes place in a suitable nutrient medium comprising carbon and nitrogen sources and inorganic salts, using procedures known in the art. Suitable media are available from commercial suppliers or may be prepared according to published compositions (e.g., in catalogues of the American Type Culture Collection). If the C4 dicarboxylic acid is secreted into the nutrient medium, the acid can be recovered directly from the medium. If the C4 dicarboxylic acid is not secreted into the medium, it can be recovered from cell lysates.

The selection and incorporation of any of the above fermentation methods is dependent on the microorganism used.

The C4 dicarboxylic acid is preferably produced by a microorganism, e.g., Aspergillus oryzae, at a concentration of preferably at least about 20 g, more preferably at least about 40 g, more preferably at least about 60 g, more preferably at least about 80 g, even more preferably at least about 100 g, most preferably at least about 120 g, and even most preferably at least about 140 g per liter.

The aqueous solution comprising a salt of the C4 dicarboxylic acid may also be obtained from methods other than fermentation, such as chemical processes. See, for example, “Top Value Added Chemicals from Biomass”, Pacific Northwest National Laboratory and National Renewable Energy Laboratory, T. Werpy and G. Petersen, August 2004, which discloses current industrial production methods for C4 diacids. For example, a common precursor to C4 dicarboxylic acids, such as succinic acid from non-fermentative processes, is maleic anhydride, which is commonly produced from benzene or n-butane.

When determining the concentration of the C4 dicarboxylic acid, any method known in the art can be used, such as UV, HPLC, NMR, IR, conductivity. In one aspect, the concentration is determined by the method described in Example 1.

Once the C4 dicarboxylic acid is produced, common separation techniques can be used to remove the biomass from the broth, such as flitration or centrifugation. If the C4 dicarboxylic acid is secreted into the nutrient medium, the C4 dicarboxylic acid can be recovered directly from the medium. If the C4 dicarboxylic acid is not secreted into the medium, the C4 dicarboxylic acid can be recovered from cell lysates.

### Electrodialysis

Electrodialysis is defined herein as a process used to transport ions from one solution through ion-exchange membranes to another solution under the influence of an applied electric potential difference. As such, electrodialysis can separate, concentrate, and/or purify a charged component of interest, e.g., a C4 dicarboxylic acid, from aqueous solutions, such as fermentation broth.

In the processes of the present invention, an aqueous solution comprising a salt of a C4 dicarboxylic acid is subjected to concentrating electrodialysis to concentrate the salt of the C4 dicarboxylic acid in the aqueous solution. In another aspect, the aqueous solution comprising a salt of a C4 dicarboxylic acid is subjected to bipolar membrane electrodialysis to convert the salt of the C4 dicarboxylic acid into the free acid of the C4 dicarboxylic acid. In another aspect, the aqueous solution comprising a salt of the C4 dicarboxylic acid is subjected to concentrating electrodialysis to concentrate the salt of the C4 dicarboxylic acid followed by bipolar membrane electrodialysis to convert the salt of the C4 dicarboxylic acid into the free acid of the C4 dicarboxylic acid.

In one aspect, sodium hydroxide produced during the processes of the present invention is recycled to a fermentation for pH control. The recycling may be conducted using methods known in the art.

Prior to electrodialysis, the pH of the aqueous solution comprising the salt of the C4 dicarboxylic acid is preferably at least 6, more preferably at least 6.5, even more preferably at least 7, most preferably at least 7.5, and even most preferably at least 8. The pH can be adjusted using common acids or bases such as acetic acid or sodium hydroxide. In a preferred aspect, the pH of the aqueous solution is adjusted using one base yielding only one salt of the C4 dicarboxylic acid. Such a base can be, for example, sodium hydroxide, potassium hydroxide, or ammonium hydroxide.

Prior to electrodialysis, the aqueous solution can be further submitted to other pretreatments such as ion exchange to remove trace amounts of mutlivalent cations such as calcium, iron, or magnesium to prevent membrane fouling and/or to decolorization using agents such as decolorizing carbon.

### Concentrating Electrodialysis

In the processes of the present invention, the first step may involve concentrating electrodialysis, which is based on the property of ion-exchange membranes. The membranes used in concentrating electrodialysis are selectively charged in order to separate ions (i.e., cations and anions). If the membrane is positively charged, only anions will be allowed through. Such a membrane is called an anion-exchange membrane. Similarly, a negatively charged membrane is called a cation-exchange membrane. This membrane property is known as permselectivity. Any anion-exchange membrane or cation-exchange membrane suitable for concentrating electrodialysis can be used in the processes of the present invention. Such membranes are commercially available from Astom Corp. (Tokyo, Japan), e.g., Neosepta membranes, Tokuyama Co., Ltd. (Tokyo, Japan), Ameridia (Somerset, N.J., USA), Eurodia Industrie S.A. (Wissous, France), CelTech, Inc. (Fayetteville, N.C., USA), Eden Purification Systems (North Haven, Conn., USA), Ion Power, Inc. (Bear, Del., USA), Minntech Corporation (Minneapolis, Minn., USA), and GE Water & Process Technologies (Trevose, Pa., USA).

The concentrating electrodialysis can be performed with any available concentrating electrodialysis unit. Such units are available commercially from suppliers such as Eet Corporation (Harriman, Tenn., USA), Mega A.S. (Drahobejlova, Praha, Czech Republic), or Ameridia (Somerset, N.J., USA), a division of Eurodia Insdustrie S.A. (Wissous, France). By way of example, a concentrating electrodialysis unit from Ameridia is described below.

The concentrating electrodialysis is preferably performed using a configuration known as an electrodialysis cell. The cell consists of a feed (diluate) compartment and a concentrate (brine) compartment formed by an anion exchange membrane and a cation exchange membrane placed between two electrodes. The electrodialysis process preferably employs multiple electrodialysis cells arranged into a configuration known as an electrodialysis stack, with alternating anion and cation exchange membranes forming the multiple electrodialysis cells. The number of cells can range from a few, e.g., ten cells, to hundreds of cells in one stack. A clamping system keeps the assembly together under a uniform closing pressure. The driving force is a direct current between anodes (positive electrodes) and cathodes (negative electrodes) housed at the two ends of the stack.

Several parameters determine the optimum range of applicability of the concentrating electrodialysis in the present invention. The parameters include current density, cell voltage, current efficiency, diluate concentration, and concentrate concentration.

The current density is the driving force of the process as it determines the quantity of equivalent grams of product that are transported across the membranes. Running at a high current density reduces the required surface of electrodialysis cells. However, the current density has to be balanced with a disproportionate cell voltage increase resulting in higher power consumption. The term “limiting current” is defined herein as the maximum allowed current density to avoid a steep cell voltage increase. The limiting current is known in the art to depend on parameters such as stack design, solution concentrations, temperature, etc.

Current efficiency also determines the surface of membranes required for the processes of the present invention. The term “current efficiency” is defined herein as the efficiency of an electrochemical process. The amount of material obtained during electrolysis is generally less than that expected due to loss of energy during its flow through the system and due to other side-reactions taking place during electrolysis. The current efficiency takes into consideration all the parasitic phenomena occurring in the stack, such as the non-perfect permselectivity of membranes or physical leakage (leading to impurities in the products), that can be reduced by optimized stack design and membrane selection.

Another important parameter is the concentrations (conductivities) of the two streams. The ratio of conductivities affects the current efficiency, limiting the maximum concentration for the concentrate (brine) stream. In general, the minimum diluate concentration is limited by conductivity considerations due to the ohmic resistance of the diluate cells and the low limiting currents at low conductivities. The minimum conductivity that can be considered is approximately 0.5 mS/cm. The minimum starting concentration of the salt of the C4 dicarboxylic acid for performing concentrating electrodialysis is one whose conductivity is preferably at least 10 mS/cm (20 g/liter), more preferably at least 20 mS/cm (40 g/liter), even more preferably at least 40 mS/cm (80 g/liter), and most more preferably at least 60 mS/cm (120 g/liter).

Membrane fouling and stack plugging can result from impurities in the aqueous solution, either soluble or insoluble, such as organic matter, colloidal substances, microorganisms (e.g., yeast or bacteria), insoluble salts, etc. In one aspect, the aqueous solution is preferably pretreated to remove impurities and particulate matter. Any pretreatment method known in the art can be used. For example, typical methods include, but are not limited to, centrifugation, microfiltration, nanofiltration, and ion exchange. However, when membranes become fouled with such impurities, they can be cleaned using standard methods known in the art such as the use of current reversal or dilute acid, caustic, and/or enzyme solutions.

Temperature and pH can also influence the effectiveness of the electrodialysis processes of the present invention. The maximum temperature range in concentrating electrodialysis stacks is typically about 10° C. to about 40° C. The maximum pH range in concentrating electrodialysis stacks is typically about 4 to about 8. However, the optimal pH range is dependent not only on the type of membrane used, but also on the pKa of the C4 dicarboxylic acid.

The concentrating electrodialysis may be conducted at a temperature in the range of about 10° C. to about 40° C., or about 15° C. to about 35° C., or about 20° C. to about 30° C.

In the processes of the present invention, the concentrating electrodialysis may be conducted at a pH that is at least about 6, at least about 6.5, at least about 7, at least about 7.5, or at least about 8.

In the electrodialysis process described herein, the aqueous solution comprising the salt of the C4 dicarboxylic acid is fed into the electrodialysis stack through the diluate compartment. When the solution arrives in the active area of the cells, the direct current (DC) voltage causes the positively charged cations to migrate toward the cathode and the negatively charged anions to migrate toward the anode. When the ions reach an ion exchange membrane, the membrane properties determine whether the ions are rejected or allowed to pass through. The ions that can pass through the membranes are retained in the next compartment since the next membrane in its path will be of the opposite charge. Therefore, there are compartments from where the ions are removed and some compartments where they are concentrated. If the solutions are circulated rapidly through the stack, a diluate and a concentrate stream are obtained. The product can be the desalted stream, the concentrate stream, or both.

The low amount of water transported with the salt across the membranes (known as “concentration transport”) enables the brine stream to have a higher concentration than the feed stream. Therefore, it is possible not only to remove salts from a solution, but also to concentrate a solution by electrodialysis. The present invention utilizes this concentrating electrodialysis to concentrate the aqueous solution of the salt of the C4 dicarboxylic acid.

The maximum concentration of the salt of the C4 dicarboxylic acid obtained by concentrating electrodialysis is about 100 g/liter, about 125 g/liter, about 150 g/liter, about 175 g/liter, about 200 g/liter, about 250 g/liter, or about 300 g/liter.

### Bipolar Membrane Electrodialysis

In the processes of the present invention, the second step may involve contacting the resulting concentrate from the concentrating electrodialysis to bipolar membrane electrodialysis to convert the salt of the C4 dicarboxylic acid into the free acid of the C4 dicarboxylic acid. However, in the processes of the present invention, it is recognized that the concentrating step may be omitted (e.g., in cases where the concentration of the C4 dicarboxylic acid is sufficiently high).

The bipolar membrane electrodialysis can be performed with any available bipolar membrane electrodialysis unit. Such units are available commercially from suppliers such as The Electrosynthesis Company, Inc. (Lancaster, N.Y., USA), FuMA-Tech GmbH (Vaihingen, Germany), Solvay SA (Brussels, Belgium), Tokuyama Co., Ltd. (Tokyo, Japan), Graver Water Co. (USA), Tianwei, Membrane Technology Co. Ltd. (Shandong, China), Ameridia (Somerset, N.J., USA), a division of Eurodia Insdustrie S.A. (Wissous, France). By way of example, a bipolar membrane electrodialysis unit from Ameridia is described below.

The bipolar membrane electrodialysis is also preferably performed using an electrodialysis cell. Bipolar membrane electrodialysis is defined herein as a process that allows efficient conversion of aqueous salt solutions into acids and bases without chemical addition. As such, bipolar membrane electrodialysis is an electrodialysis process where bipolar membranes carry out the dissociation of water, also called water splitting, in the presence of an electric field. In addition, this process allows one to directly acidify or basify process streams without adding chemicals, avoiding by-product or waste streams and costly downstream purification steps.

Under the driving force of an electrical field, a bipolar membrane dissociates water into hydrogen (H+) and hydroxyl (OH−) ions. A bipolar membrane is formed of an anion- and a cation-exchange layer that are bound together, and a very thin interface where the water diffuses from the outside aqueous salt solutions. With the anion-exchange side facing the anode and the cation-exchange side facing the cathode, the hydroxyl anions will be transported across the anion-exchange layer and the hydrogen cations across the cation-exchange layer. A bipolar membrane allows the generation and concentration of hydroxyl and hydrogen ions at its surface. These ions can be used in an electrodialysis stack to combine with the cations and anions of the salt to produce acids and bases. In the present invention, bipolar membrane electrodialysis is used to convert a solution of the salt of the C4 dicarboxylic acid to the free acid of the C4 dicarboxylic acid.

Any bipolar membrane suitable for bipolar membrane electrodialysis can be used in the processes of the present invention. Such membranes are commercially available from Astom Corp. (Tokyo, Japan), e.g., Neosepta membranes, Tokuyama Co., Ltd. (Tokyo, Japan), Ameridia (Somerset, N.J., USA), Eurodia Industrie S.A. (Wissous, France), CelTech, Inc. (Fayetteville, N.C., USA), Eden Purification Systems (North Haven, Conn., USA), Ion Power, Inc. (Bear, Del., USA), Minntech Corporation (Minneapolis, Minn., USA), and GE Water & Process Technologies (Trevose, Pa., USA)

The same parameters for performing concentrating electrodialysis also apply to the bipolar membrane electrodialysis processes of the present invention; i.e., current density, cell voltage, current efficiency, diluate concentration, concentrate concentration, pH, temperature, etc.

The minimum starting concentration of the salt of the C4 dicarboxylic acid for performing bipolar membrane electrodialysis is one whose conductivity is preferably at least 10 mS/cm (20 g/liter).

The bipolar membrane electrodialysis is conducted at a temperature in the range of about 10° C. to about 40° C., about 15° C. to about 35° C., or about 20° C. to about 30° C.

The bipolar membrane electrodialysis may be conducted at a pH that is at least about 6, at least about 6.5, at least about 7, at least 7.5 about, or at least about 8.

The maximum concentration of the free acid of the C4 dicarboxylic acid obtained by bipolar membrane electrodialysis is preferably about 300 g/liter.

In the processes of the present invention, the conversion of the salt of the C4 dicarboxylic acid to the free acid of the C4 dicarboxylic acid is at least 90%, at least 92%, at least 95%, or at least 98%.

It is understood herein that the concentrating electrodialysis unit and the bipolar membrane electrodialysis unit can be integrated into the same apparatus. Different bipolar membrane electrodialysis configurations are possible and described by manufacturers. A three-compartment cell is obtained by adding the bipolar membrane in a concentrating electrodialysis cell. In such a case, the bipolar membrane is flanked on either side by the anion- and cation-exchange membranes described above to form three compartments: acid between the bipolar and the anion-exchange membranes, base between the bipolar and the cation- exchange membranes, and salt between the cation- and anion-exchange membranes. A two-compartment cell can be obtained by adding bipolar and cation-exchange membranes or by adding bipolar and anion-exchange membranes. In the present invention, a two compartment cell with alternating cation-exchange membranes and bipolar membranes is utilized.

### Recovery

While the salt of the C4 dicarboxylic acid or the free acid of the C4 dicarboxylic acid obtained according to the processes of the present invention may be used as is, the processes may further comprise recovering the salt of the C4 dicarboxylic acid or the free acid of the C4 dicarboxylic acid using any method known in the art. Such non-limiting methods may include precipitation e.g., calcium sulfate, crystallization, and extraction.

### Uses of the C4 Dicarboxylic Acids

The C4 dicarboxylic acid obtained according to the processes of the present invention can be used to obtain other organic compounds such as tetrahydrofuran, 1,4 butanediol, N-methylpyrollidinone, and gamma-butyrolactone, among other chemicals. Tetrahydrofuran is important for the production of certain specialty urethane polymers as well as being an industrial organic solvent. 1,4 Butanediol is a co-monomer in polyester polymers including poly(butylenes terephthalate) or PBT.

The present invention is further described by the following examples that should not be construed as limiting the scope of the invention.

### EXAMPLES

### Electrodialysis

A EUR2B pilot scale electrodialysis unit from Ameridia (Somerset, N.J., USA), a Division of Eurodia Industries S.A. (Wissous, France), was used in the Examples below. The unit was supplied with two electrodialysis stacks, one for concentrating electrodialysis (EUR2B-10 stack) and the other (EUR2B-7Bip) for bipolar membrane electrodialysis.

The EUR2B-10 stack consists of 10 cells with alternating anion- and cation-exchange membranes (NEOSEPTA® ion exchange membranes (Astom Corp., Tokyo, Japan). The area of each membrane was 2dm². The EUR2B-10 stack was used for concentrating a sodium 3-hydroxypropionate solution.

The EUR2B-7Bip stack consists of 7 cells with alternating cationic and bipolar membranes (NEOSEPTA® BP-1E membranes (Astom Corp., Tokyo, Japan). The area of each membrane was 2dm². The EUR2B-7Bip stack was used for converting a solution of sodium malate to its free acid.

### Example 1

### HPLC Quantitation of Malic Acid

Quantitation of malic acid was conducted by Reverse Phase High Pressure Liquid Chromatography (RP-HPLC) using an AGILENT® 1200 Series Binary LC System and AGILENT® 1200 Series Diode Array Detector (DAD) (Agilent Technologies, Santa Clara, Calif. USA). Reverse phase separation was performed using a PHENOMENEX® Aqua 5μ C18 125Å 205×4.6 mm ID column and PHENOMENEX® AQ C18 4×3.0 mm Security Guard Cartridge (Phenomenex, Inc., Torrance, Calif., USA). The mobile phase consisted of 10% methanol (HPLC grade) and 90% 145 mM phosphate pH 1.5 buffer.

Samples were diluted 1:10 in the mobile phase. The samples were then filtered through a a 25 mm 0.45 micron polyethersulfone membrane (Whatman, Florham Park, N.J., USA) and 1.5 ml of the filtrates were placed into a HPLC vial for acid analysis. RP-HPLC was performed using an injection volume of 10 μl at a flow rate of 0.7 ml/minute (isocratic) and column temperature at 25° C. Detection was at 210 nm, 8 nm bandwidth, with the reference at 360 nm, 40 nm bandwidth. The run time was 11 minutes.

The void time was determined to be 3.8 minutes. The quantitative capabilities of the reverse phase method were determined for malic acid by performing replicate injections of serially diluted malic acid standards with concentrations ranging from 49.2-3.93 mM. The relative standard deviation for (RSD) for replicate injections waS 5%. Malic acid shows R²≧0.9999.

### Example 2

### Fermentation of Aspergillus oryzae NRRL 3488

Aspergillus oryzae NRRL 3488 was grown for approximately 7 days at 32° C. on PDA plates (39 g of potato dextrose agar per liter of deionized water). Five-six ml of sterile 50 mM sodium phosphate pH 6.8 containing 0.1% TWEEN® 80 were added to each of the plates and spores were suspended by scraping with an inoculating loop. Suspended spores were pipetted off each of the plates and transferred to 50 ml conical tubes. Twenty-five ml of sterile 50 mM sodium phosphate pH 6.8 containing 0.1% TWEEN® 80 were added to each of three 500 ml non-baffled plastic flasks containing 75 ml of a seed medium, which was then inoculated with 2 ml of the spore suspensions. The seed medium was composed per liter of 40 g of glucose, 4.0 g of (NH₄)₂SO₄, 0.75 g of KH₂PO₄, 0.75 g of K₂HPO₄, 0.1 g of MgSO₄.7H₂O, 0.1 g of CaCl₂ 2H₂O, 0.005 g of FeSO₄.7H₂O, and 0.005 g of NaCl. The flasks were then incubated at 32° C. and 180 rpm for about 24 hours. Three seed flasks were combined to supply the 144 ml inoculum required per tank.

Three 3-liter fermentors were batched with 1.8 L each of medium composed per liter of 120 g of glucose, 90.0 g of CaCO₃, 6.0 g of Bacto peptone, 0.150 g of KH₂PO₄, 0.150 g of K₂HPO₄, 0.10 g of MgSO₄.7H₂O, 0.10 g of CaCl₂ 2H₂O, 0.005 g of FeSO₄.7H₂O, and 0.005 g of NaCl. One ml of Pluronic antifoam was added to each tank.

Fermentors were equilibrated at 32±0.1° C. and stirred at 500 rpm. Inlet air flow was maintained at 1 v/v/m. A sterile solution of 15% sodium carbonate in deionized water was prepared and used to maintain the pH at 6.50±0.1.

The fermentors were inoculated by introducing 144 ml (8%) of the seed culture broth from three combined seed flasks. Samples were withdrawn daily and analyzed for malic acid production. Fermentations were completed after 7 days.

Fermentations were ended at 187 hours, and broths were harvested by centrifugation using a Sorvall Legend RT benchtop centrifuge at 4000×g for 20 minutes. The resulting supernatant was then further clarified by decanting through two layers of MIRACLOTH®. The final malic acid concentrations of each of the fermentations, determined by HPLC as described in Example 1, were as follows: MAL017, 47.3 g/L; MAL018, 46.9 g/L; and MAL019, 45.2 g/L.

### Example 3

### Electrodialysis of Sodium Malate Using the EDC Configuration

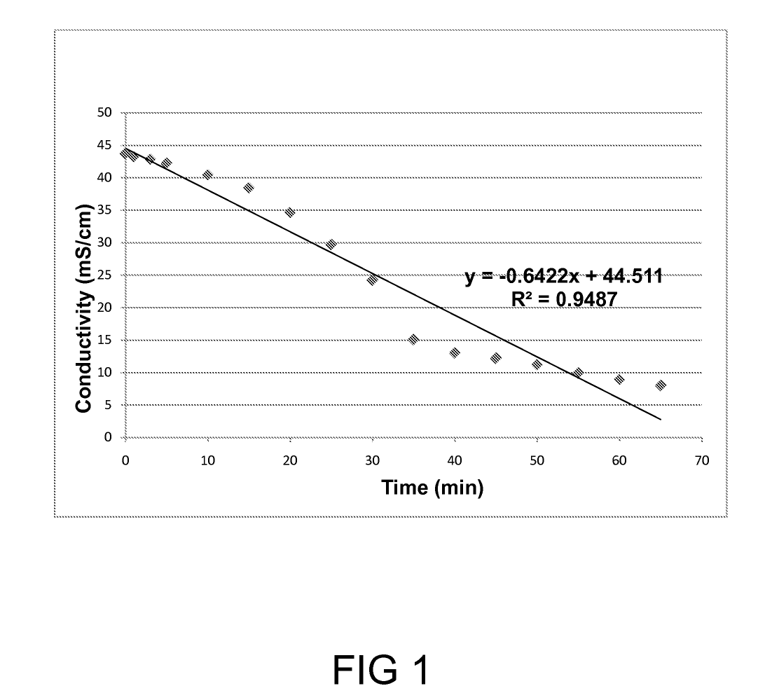

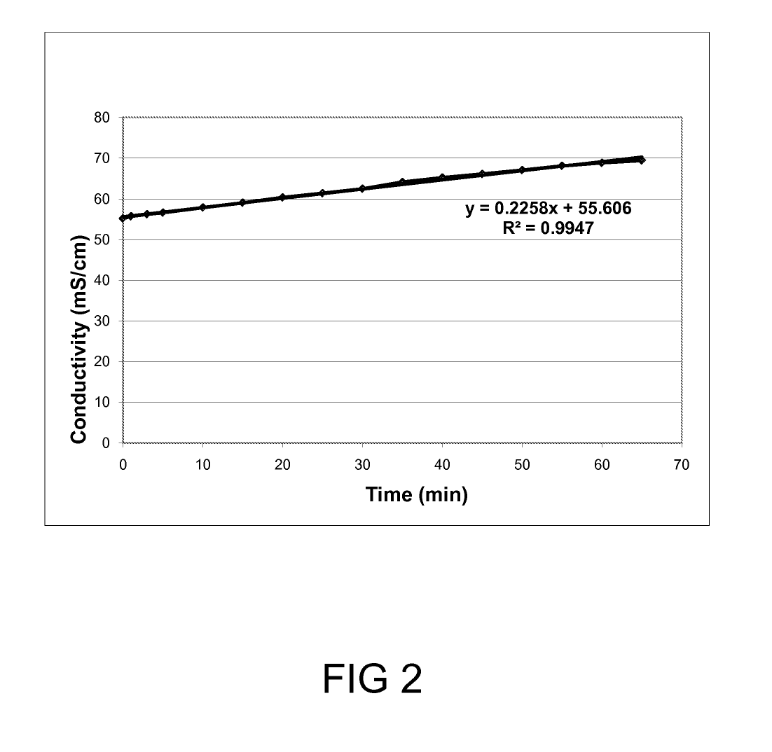

A clear, brown solution of sodium malate (ca. 50 g/L by HPLC; Example 1) from the fermentations (2.78 kg, 43.7 mS/cm, pH 6.4) described in Example 2 was charged to the diluate tank. Separately, for the brine tank, a solution of commercially obtained malic acid (200 g) was dissolved into water (1 kg) and was adjusted to pH 7 with 50% caustic. Water was added to bring the total mass to 2 kg and the solution was placed into the brine tank. The conductance of this sodium malate solution in the brine tank was 55.1 mS/cm. Potassium nitrate (20 mS/cm) was added to the electrode rinse tank. The voltage was set to 14 volts and the amperage was initially at 4.1 amps. After 65 minutes run time, the conductivity in the diluate tank dropped to 8 mS/cm and the conductivity in the brine tank rose to 69 mS/cm. This final conductivity corresponds to a final concentration of 14% (w/w) sodium malate when compared to the standard solution. The pH in the brine tank was about 6.9. The color of the diluate tank remained dark brown in appearance while the color of the brine tank was colorless, indicating the non-migration of colored components. The voltage remained at 14 volts and the amperage had dropped to 3.8 amps and the run was ended. FIG. 1 plots the change in solution conductivity of the diluate tank versus time and FIG. 2 shows the change in conductivity of the brine tank versus time.

### Example 4

### Formation of Malic Acid from Sodium Malate Using the EDBM Configuration

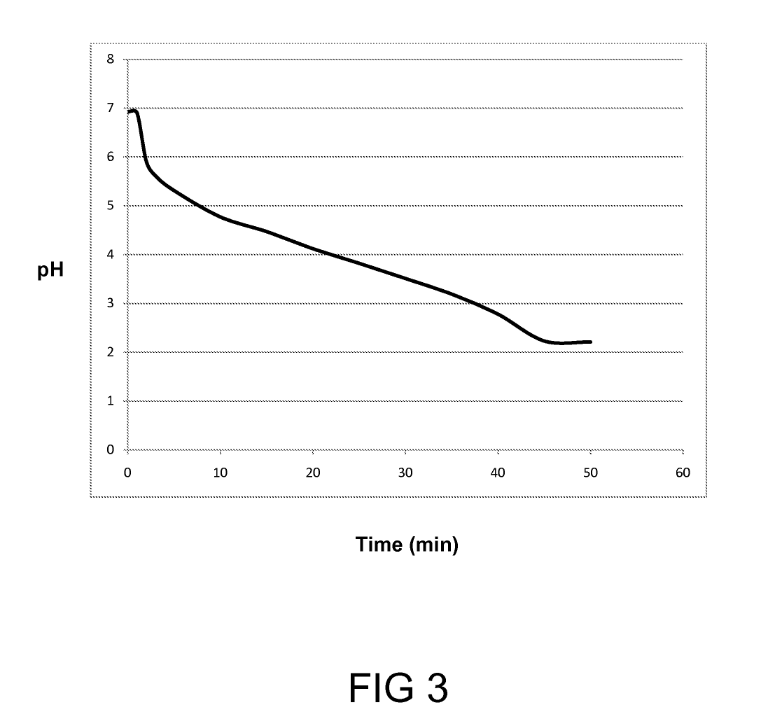

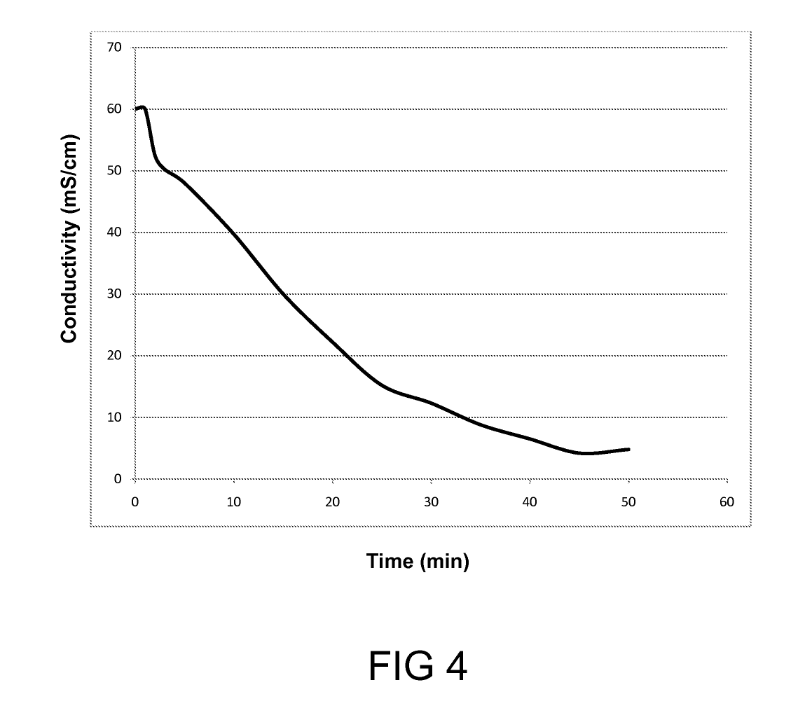

A solution of sodium malate (2.3 kg, 60.0 mS/cm, pH 6.92) was charged to the acid tank. A solution of NaOH (4 kg, 1.0 M) was charged to the electrode rinse tank. A solution of NaOH (4 kg, 0.5 M) was charged to the base tank. Each of the solutions was circulated through the EDBM membrane stack at a flow rate of about 0.8 gpm. The DC power supply was turned on with initial settings of 20 amps and 23.5 volts. During the run, the pH and conductivity dropped within the acid tank as shown in FIGS. 3 and 4, respectively, while the conductivity in the base tank rose from initially 186 mS/cm to a final conductivity of 323 mS/cm. The run was ended when the conductivity in the acid tank dropped sufficiently low and back-migration of sodium ion to the acid tank began (50 minutes).

The present invention may be described by the following numbered paragraphs:
[1] A process for separating and recovering a C4 dicarboxylic acid, comprising:
(a) subjecting an aqueous solution comprising a salt of the C4 dicarboxylic acid to concentrating electrodialysis to concentrate the salt of the C4 dicarboxylic acid in the aqueous solution; and
(b) subjecting the resulting concentrate to bipolar membrane electrodialysis to convert the salt of the C4 dicarboxylic acid into the free acid of the C4 dicarboxylic acid.
[2] The process of paragraph 1, which furthers comprises: (c) recovering the free acid of the C4 dicarboxylic acid.
[3] The process of paragraph 1 or 2, wherein the aqueous solution is a fermentation broth.
[4] The process of paragraph 3, wherein the fermentation broth is a cell-free fermentation broth.
[5] The process of any of paragraphs 1-4, wherein the C4 dicarboxylic acid is produced by a microorganism at a concentration of preferably at least about 20 g, more preferably at least about 40 g, more preferably at least about 60 g, more preferably at least about 80 g, even more preferably at least about 100 g, most preferably at least about 120 g, and even most preferably at least about 140 g per liter.
[6] The process of any of paragraphs 1-5, wherein the salt of the C4 dicarboxylic acid consists of the conjugate base of the C4 dicarboxylic acid and a cation.
[7] The process of paragraph 6, wherein the cation is a monovalent or divalent cation.
[8] The process of paragraph 7, wherein the monovalent cation is sodium, potassium, or ammonium.
[9] The process of any of paragraphs 1-8, wherein the pH of the aqueous solution comprising the salt of the C4 dicarboxylic acid is preferably at least 6, more preferably at least 6.5, even more preferably at least 7, most preferably at least 7.5, and even most preferably at least 8.
[10] The process of any of paragraphs 1-9, wherein the minimum starting concentration of the salt of the C4 dicarboxylic acid in the concentrating electrodialysis is one whose conductivity is preferably at least 10 mS/cm, more preferably at least 20 mS/cm, even more preferably at least 40 mS/cm, and most more preferably at least 60 mS/cm.
[11] The process of any of paragraphs 1-10, wherein the concentrating dialysis is conducted at a temperature in the range of about 10° C. to about 40° C., more preferably about 15° C. to about 35° C., and most preferably about 20° C. to about 30° C.
[12] The process of any of paragraphs 1-11, wherein the concentrating electrodialysis is conducted at a pH that is preferably at least 6, more preferably at least 6.5, even more preferably at least 7, most preferably at least 7.5, and even most preferably at least 8.0.
[13] The process of any of paragraphs 1-12, wherein the maximum concentration of the salt of the C4 dicarboxylic acid obtained by concentrating electrodialysis is preferably about 100 g/liter, more preferably about 125 g/liter, more preferably about 150 g/liter, more preferably about 175 g/liter, more preferably about 200 g/liter, even more preferably about 250 g/liter, and most preferably about 300 g/liter.
[14] The process of any of paragraphs 1-13, wherein the minimum starting concentration of the salt of the C4 dicarboxylic acid during bipolar membrane electrodialysis is one whose conductivity is preferably at least 10 mS/cm.
[15] The process of any of paragraphs 1-14, wherein the bipolar membrane electrodialysis is conducted at a temperature in the range of preferably about 10° C. to about 40° C., more preferably about 15° C. to about 35° C., and most preferably about 20° C. to about 30° C.
[16] The process of any of paragraphs 1-15, wherein the bipolar membrane electrodialysis is conducted at a pH that is preferably at least 6, more preferably at least 6.5, even more preferably at least 7, most preferably at least 7.5, and even most preferably at least 8.
[17] The process of any of paragraphs 1-16, wherein the maximum concentration of the free acid of the C4 dicarboxylic acid obtained by bipolar membrane electrodialysis is preferably about 300 g/liter.
[18] The process of any of paragraphs 1-17, wherein the conversion of the salt of the C4 dicarboxylic acid to the free acid of the C4 dicarboxylic acid is preferably at least 90%, more preferably at least 92%, even more preferably at least 95%, and most preferably at least 98%.
[19] The process of any of paragraphs 1-18, wherein sodium hydroxide produced is recycled to a fermentation for pH control.
[20] A process for separating and recovering a salt of the C4 dicarboxylic acid, comprising: subjecting an aqueous solution comprising the salt of the C4 dicarboxylic acid to concentrating electrodialysis to concentrate the salt of the C4 dicarboxylic acid in the aqueous solution.
[21] The process of paragraph 20, which further comprises recovering the salt of the C4 dicarboxylic acid.
[22] The process of paragraph 20 or 21, wherein the aqueous solution is a fermentation broth.
[23] The process of paragraph 22, wherein the fermentation broth is a cell-free fermentation broth.
[24] The process of any of paragraphs 20-23, wherein the C4 dicarboxylic acid is produced by the microorganism at a concentration of preferably at least about 20 g, more preferably at least about 40 g, more preferably at least about 60 g, more preferably at least about 80 g, even more preferably at least about 100 g, most preferably at least about 120 g, and even most preferably at least about 140 g per liter

[25] The process of any of paragraphs 20-24, wherein the salt of the C4 dicarboxylic acid consists of the conjugate base of the C4 dicarboxylic acid and a cation.
[26] The process of paragraph 25, wherein the cation is a monovalent or divalent cation.
[27] The process of paragraph 26, wherein the monovalent cation is sodium, potassium, or ammonium.
[28] The process of any of paragraphs 20-27, wherein the pH of the aqueous solution comprising the salt of the C4 dicarboxylic acid is preferably at least 6, more preferably at least 6.5, even more preferably at least 7, most preferably at least 7.5, and even most preferably at least 8.
[29] The process of any of paragraphs 20-28, wherein the minimum starting concentration of the salt of the C4 dicarboxylic acid in the concentrating electrodialysis is one whose conductivity is preferably at least 10 mS/cm, more preferably at least 20 mS/cm, even more preferably at least 40 mS/cm, and most more preferably at least 60 mS/cm.
[30] The process of any of paragraphs 20-29, wherein the concentrating dialysis is conducted at a temperature in the range of about 10° C. to about 40° C., more preferably about 15° C. to about 35° C., and most preferably about 20° C. to about 30° C.

[31] The process of any of paragraphs 20-30, wherein the concentrating electrodialysis is conducted at a pH that is preferably at least 6, more preferably at least 6.5, even more preferably at least 7, most preferably at least 7.5, and even most preferably at least 8.0.
[32] The process of any of paragraphs 20-31, wherein the maximum concentration of the salt of the C4 dicarboxylic acid obtained by concentrating electrodialysis is preferably about 100 g/liter, more preferably about 125 g/liter, more preferably about 150 g/liter, more preferably about 175 g/liter, more preferably about 200 g/liter, even more preferably about 250 g/liter, and most preferably about 300 g/liter.
[33] A process for separating and recovering the C4 dicarboxylic acid, comprising: subjecting an aqueous solution comprising a salt of the C4 dicarboxylic acid to bipolar membrane electrodialysis to convert the salt of the C4 dicarboxylic acid into the free acid of the C4 dicarboxylic acid.
[34] The process of paragraph 33, which further comprises recovering the free acid of the C4 dicarboxylic acid.
[35] The process of paragraph 33 or 34, wherein the salt of the C4 dicarboxylic acid consists of the conjugate base of the C4 dicarboxylic acid and a cation.
[36] The process of paragraph 35, wherein the cation is a monovalent or divalent cation.
[37] The process of paragraph 36, wherein the monovalent cation is sodium, potassium, or ammonium.
[38] The process of any of paragraphs 33-37, wherein the minimum starting concentration of the salt of the C4 dicarboxylic acid during bipolar membrane electrodialysis is one whose conductivity is preferably at least 10 mS/cm.
[39] The process of any of paragraphs 33-38, wherein the bipolar membrane electrodialysis is conducted at a temperature in the range of preferably about 10° C. to about 40° C., more preferably about 15° C. to about 35° C., and most preferably about 20° C. to about 30° C.
[40] The process of any of paragraphs 33-39, wherein the bipolar membrane electrodialysis is conducted at a pH that is preferably at least 6, more preferably at least 6.5, even more preferably at least 7, most preferably at least 7.5, and even most preferably at least 8.
[41] The process of any of paragraphs 33-40, wherein the maximum concentration of the free acid of the C4 dicarboxylic acid obtained by bipolar membrane electrodialysis is preferably about 300 g/liter.
[42] The process of any of paragraphs 33-41, wherein the conversion of the salt of the C4 dicarboxylic acid to the free acid of the C4 dicarboxylic acid is preferably at least 90%, more preferably at least 92%, even more preferably at least 95%, and most preferably at least 98%.
[43] The process of any of paragraphs 33-42, wherein sodium hydroxide produced is recycled to a fermentation for pH control.
[44] The process of any of paragraphs 1-43, wherein the C4 dicarboxylic acid is malic acid.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

1. A process for separating and recovering the C4 dicarboxylic acid, comprising: subjecting an aqueous solution comprising a salt of the C4 dicarboxylic acid to bipolar membrane electrodialysis to convert the salt of the C4 dicarboxylic acid into the free acid of the C4 dicarboxylic acid, and recovering the free acid of the C4 dicarboxylic acid.

2. A process for separating and recovering a C4 dicarboxylic acid, comprising:
(a) subjecting an aqueous solution comprising a salt of the C4 dicarboxylic acid to concentrating electrodialysis to concentrate the salt of the C4 dicarboxylic acid in the aqueous solution; and
(b) subjecting the resulting concentrate to bipolar membrane electrodialysis to convert the salt of the C4 dicarboxylic acid into the free acid of the C4 dicarboxylic acid; and
(c) recovering the free acid of the C4 dicarboxylic acid.

3. The process of claim 2, wherein the aqueous solution is a fermentation broth.

4. The process of claim 3, wherein the fermentation broth is a cell-free fermentation broth.

5. The process of claim 2, wherein the C4 dicarboxylic acid is produced by a microorganism at a concentration of at least 20 g per liter.

6. The process of claim 2, wherein the salt of the C4 dicarboxylic acid comprises a sodium, potassium, or ammonium cation.

7. The process of claim 2, wherein the pH of the aqueous solution comprising the salt of the C4 dicarboxylic acid is at least 6.

8. The process of claim 2, wherein the minimum starting concentration of the salt of the C4 dicarboxylic acid in the concentrating electrodialysis is one whose conductivity is preferably at least 10 mS/cm.

9. The process of claim 2, wherein the concentrating electrodialysis is conducted at a temperature in the range of about 10° C. to about 40° C.

10. (canceled)

11. The process of claim 2, wherein the concentration of the salt of the C4 dicarboxylic acid obtained by concentrating electrodialysis is at least 100 g/liter.

12. The process of claim 2, wherein the minimum starting concentration of the salt of the C4 dicarboxylic acid during bipolar membrane electrodialysis is one whose conductivity is preferably at least 10 mS/cm.

13. The process of claim 2, wherein the bipolar membrane electrodiaiysis is conducted at a temperature in the range of about 10° C. to about 40° C.

14. The process of claim 2, wherein the bipolar membrane electrodialysis is conducted at a starting pH that is at least 6.

15. The process of claim 2, wherein the concentration of the free acid of the C4 dicarboxylic acid obtained by bipolar membrane electrodialysis is at least about 300 g/liter.

16. The process of claim 2, wherein the conversion of the salt of the C4 dicarboxylic acid to the free acid of the C4 dicarboxylic acid is at least 90%.

17. The process of claim 2, wherein sodium hydroxide is produced and is recycled to a fermentation for pH control.

18. The process of claim 2, wherein the C4 dicarboxylic acid is malic acid.

19. The process of claim 2, wherein the salt of the C4 dicarboxylic acid comprises a sodium cation.

20. The process of claim 2, wherein the concentration of the salt of the C4 dicarboxylic acid obtained by concentrating electrodialysis is at least 200 g/liter.

21. The process of claim 2, wherein the conversion of the salt of the C4 dicarboxylic acid to the free acid of the C4 dicarboxylic acid is at least 95%.
